(19) United States
(12) Patent Application Publication
(10) Pub. No.: US 2018/0255182 A1
(43) Pub. Date: Sep. 6, 2018

(54) Web Real-Time Client Communication Over a Stimulus Based Network

(71) Applicant: E-MetroTel Global Inc., Plano, TX (US)

(72) Inventors: Stephane Cliche, Orleans (CA); Ardavan Nawaby, Plano, TX (US); Steve Pallen, Kanata (CA); Joseph Abraham, Belleville (CA); Misha Vodsedalek, Prague (CZ)

(21) Appl. No.: 15/970,937

(22) Filed: May 4, 2018

Related U.S. Application Data
(63) Continuation of application No. 15/652,301, filed on Jul. 18, 2017, now abandoned.
Application No. 15/652,301 is a continuation of application No. 15/651,660, filed on Jul. 17, 2017, now abandoned.
(60) Provisional application No. 62/363,103, filed on Jul. 15, 2016.

(51) Int. Cl. H04M 7/00; H04L 29/06

(52) U.S. Cl. CPC H04M 7/006; H04L 65/608

(57) ABSTRACT

The present invention is directed to a system and process for bidirectional emulation supporting for call communication between WebRTC clients and non-WebRTC clients. Certain embodiments of system include an emulator module having a traffic event dictionary. The traffic event dictionary includes event traffic entries corresponding to traffic events for WebRTC clients. The line signal dictionary includes stimulus protocol based instructions corresponding to WebRTC event traffic entries. The traffic event dictionary also includes event traffic entries corresponding to traffic events for non-WebRTC clients. The line signal dictionary further includes stimulus protocol based instructions corresponding to the non-WebRTC event traffic entries. The emulator module is configured to receive and monitor incoming and outgoing event traffic between a WebRTC client and a non-WebRTC. The emulator module is further configured to retrieve the event traffic entries for the WebRTC clients from the traffic event dictionary and retrieve the event traffic entries for the non-WebRTC clients from the traffic event dictionary. Additionally, the emulator module is configured to translate the WebRTC client event traffic to the non-WebRTC client event traffic over their respective stimulus protocol based instructions corresponding to their respective event traffic entries.

### BACKGROUND

### Field of the Invention

The present invention is in the field of telephony, and more particularly, for communications in telephony.

### Description of the Related Art

The use of computer based communications technology, systems and related applications are helping establish new methods of communicating between individuals, enterprises, and organizations alike. Web Real-Time Communications (WebRTC) represents an ongoing effort to develop industry standards for integrating real-time communications functionality into clients, such as web browsers, and enable communication with other web clients. Development of interfaces such as WebRTC browser-to-browser applications, whether it is for desktop computers or mobile devices, enables this connectivity and exchange of information between various parties. WebRTC is limited in its ability to establish connectivity to other communications technologies that have been widely used and deployed by enterprises.

Voice over IP (VoIP) technology and Session Initiated Protocol (SIP) communications technology have also seen significant deployments by Enterprises. VoIP telephone devices represent a large end client installed base. These communications technologies enabled bridging of voice centric and data centric system together, helping simplify communications system deployments. Compatibility and support challenges of mixed communications technology and mixed vendor solutions or lack thereof are limiting enterprises ability to lower communications costs and furthermore limits flexibility in choice of end clients such as browser based computer centric desktop or mobile client applications.

It would be advantageous to lower the barrier in communications between WebRTC client and non-WebRTC client communication.

### SUMMARY

The present invention is directed to a system and process for bidirectional emulation supporting for call communication between WebRTC clients and non-WebRTC clients. Certain embodiments of system include an emulator module having a traffic event dictionary. The traffic event dictionary includes event traffic entries corresponding to traffic events for WebRTC clients. The line signal dictionary includes stimulus protocol based instructions corresponding to WebRTC event traffic entries. The traffic event dictionary also includes event traffic entries corresponding to traffic events for non-WebRTC clients. The line signal dictionary further includes stimulus protocol based instructions corresponding to the non-WebRTC event traffic entries. The emulator module is configured to receive and monitor incoming and outgoing event traffic between a WebRTC client and a non-WebRTC. The emulator module is further configured to retrieve the event traffic entries for the WebRTC clients from the traffic event dictionary and retrieve the event traffic entries for the non-WebRTC clients from the traffic event dictionary. Additionally, the emulator module is configured to translate the WebRTC client event traffic to the non-WebRTC client event traffic over their respective stimulus protocol based instructions corresponding to their respective event traffic entries.

These and other features, aspects, and advantages of the invention will become better understood with reference to the following description, appended claims, and accompanying drawings.

### BRIEF DESCRIPTION OF THE DRAWINGS

FIG. 1 is a block diagram of an embodiment of the invention as it may exist in operation;

FIG. 2 is a block diagram of an embodiment of the invention as it may exist in operation;

FIG. 3 is a representative WebRTC network stack;

FIG. 4 is a representative WebRTC client stack;

FIG. 5 is a representative WebRTC client stack;

FIG. 6 is a representative WebRTC event library;

FIG. 7 is a representative SIP communication stack;

FIG. 8 is a representative WebRTC client interface;

FIG. 9 is a representative WebRTC client to WebRTC client initial communication flow diagram;

FIG. 10 is a representative SIP client to SIP client initial communication flow diagram;

FIGS. 11A and 11B are representative WebRTC client to non-WebRTC interaction stacks in the form of a WebRTC client to SIP client interaction;

FIGS. 12A-12C are diagrams of representative examples of a non-WebRTC clients in the form of an analog telephone, a digital telephone, and a VoIP telephone;

FIG. 13 is a block diagram of an embodiment of a communication server according to the current invention;

FIG. 14 is a block diagram of an embodiment of a system as it may exist in operation;

FIG. 15 is a representative process diagram for an embodiment according to the current invention;

FIG. 16 is a representative partial telephone event library; and

FIGS. 17A-17C are diagrams of representative partial call session from a WebRTC client to a non-WebRTC client.

### DETAILED DESCRIPTION

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Web Real-Time Communications (WebRTC) represents an ongoing effort to develop industry standards for integrating real-time communications functionality into web clients, such as web browsers, to enable direct interaction with other web clients. WebRTC provides built-in capabilities for establishing real-time audio 22, video 22, and/or data streams 22 in interactive sessions.

There are many applications of the Internet that require the creation and management of a communication session, where a session is considered an exchange of data between an association of participants. Implementation of the various applications is further complicated by the practices of participants, where users may move between endpoints and they may communicate using several different media types, sometimes simultaneously. Numerous telephony protocols have been created that employ various call signaling and carry various forms of real-time multimedia session data such as voice, video, or text messages and are implemented on different client types. Some employ thinner clients and intelligent centralized servers while others employ more intelligent clients with less centralized processing required.

Existing infrastructure and protocols for providing interactive communications, such as Session Initiation Protocol (SIP), may not be compatible with WebRTC due to new features and media extensions provided by WebRTC. Varying levels of WebRTC support that are currently provided by different WebRTC clients may present further compatibility and support issues for gateway applications.

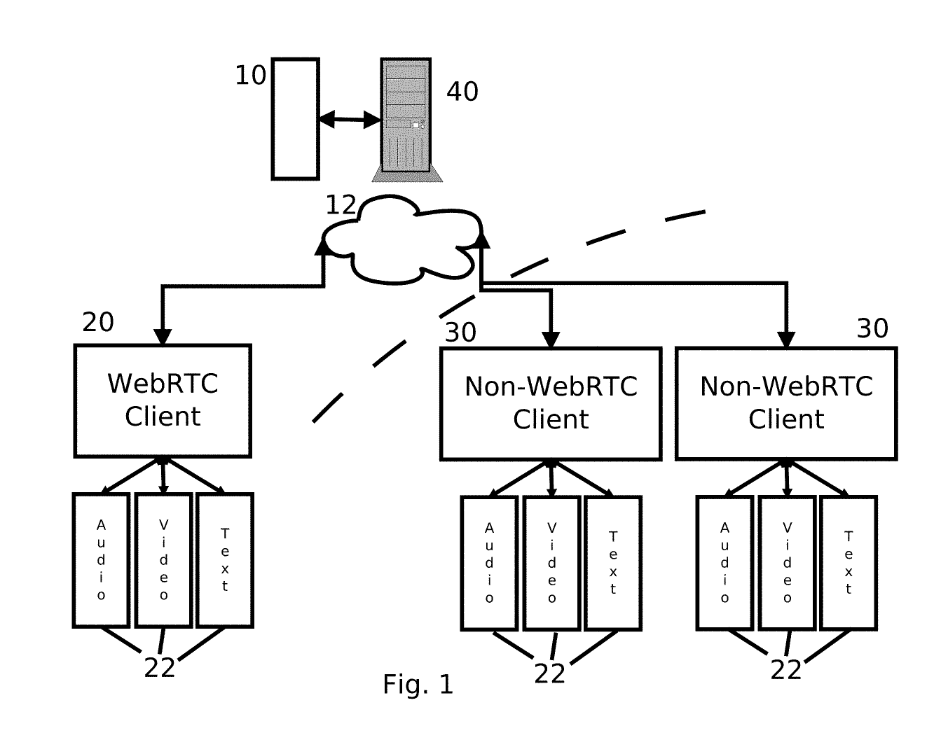

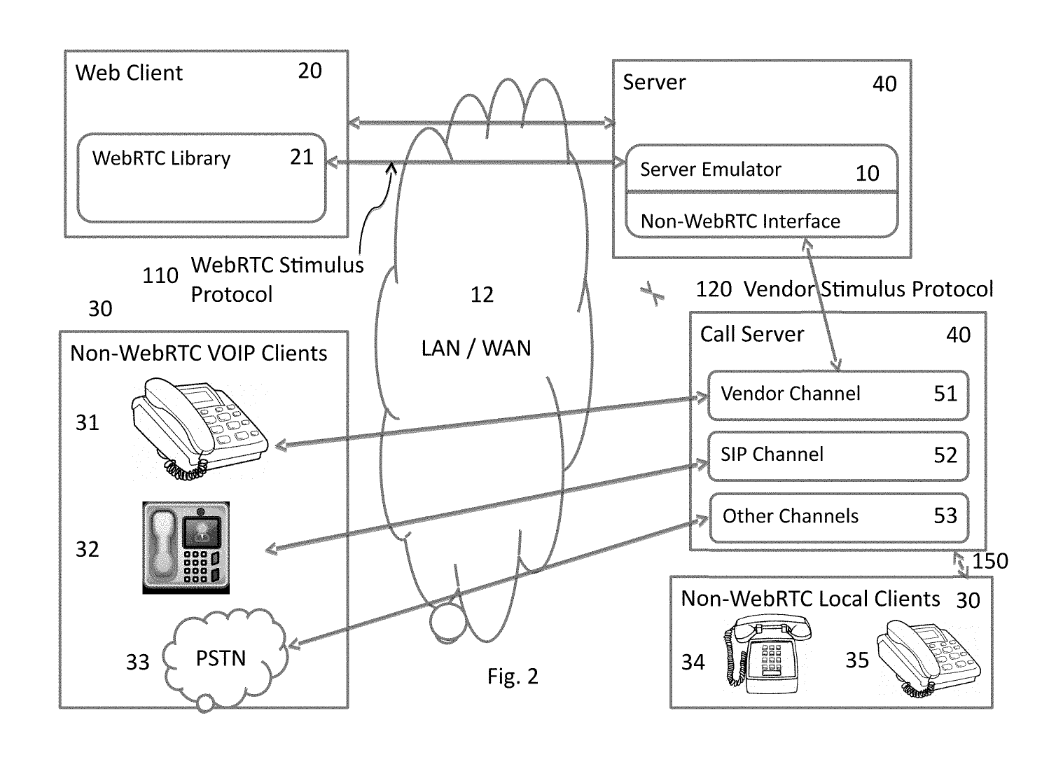

The present invention is directed to a systems and processes for enabling feature rich calls between WebRTC clients, extending WebRTC client call features not natively supported by WebRTC, and enabling communication between Web RTC clients and non-WebRTC clients. FIGS. 1 and 2 depict embodiments of systems as they may exist in operation. Depicted is a WebRTC client 20 in communication with one or more non-WebRTC clients 30 over a network 12, the communication facilitated by a call server 40 including an emulator module 10. The emulator module 10 translates the traffic between the clients 20 30 facilitating communication between them. The emulator module 10 provides WebRTC signaling to WebRTC network facing clients 20 and non-WebRTC signaling to non-WebRTC network facing clients 30.

In exemplary configuration, the emulator module 10 is carried out on a call server 40. An exemplary call server 40 primarily facilitates the setup of calls in the network. An exemplary communication server 40 includes a first facing network interface 226 and a second facing network interface 227. The software components in conjunction with the processor, control logic, LAN interface and network interface, enable the call server 40 to establish communication sessions.

The WebRTC clients 20 implement the WebRTC protocol. The WebRTC protocol teaches peer-to-peer audio, video, and data communications. This real-time communications functionality is accessible by web developers via standard markup tags, such as those provided by version 5 of the Hypertext Markup Language (HTMLS), and client-side scripting Application Programming Interfaces (APIs), such as JavaScript APIs. More information regarding WebRTC may be found in “WebRTC: APIs and RTCWEB Protocols of the HTMLS Real-Time Web,” by Alan B. Johnston and Daniel C. Burnett (2012 Digital Codex LLC). The WebRTC standards are currently under joint development by the World Wide Web Consortium (W3C) and the Internet Engineering Task Force (IETF). Information on the current state of WebRTC standards can be found at, e.g., http://www.w3c.org and http://www/ietf.org.

There are three primary types of information that are exchanged during this signaling before the WebRTC session can begin. First, control messages are used to set up, open, and close the communication channel, and to handle errors. Second, information needed in order to set up the connection, including the IP addressing and port information needed for the peers to be able to talk to one another. Third, media capability negotiation, including codecs and media data formats that the peers can understand.

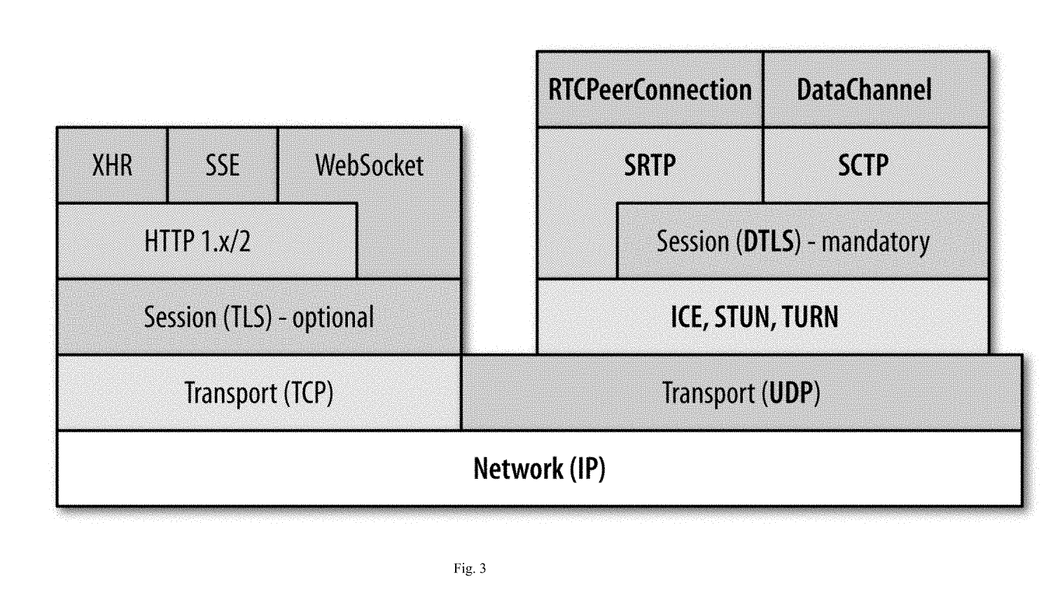

FIG. 3 depicts a representative WebRTC client network focused protocol stack. The protocol includes network, signaling, and sessions aspects. In order to communicate with another WebRTC client, each client agrees to begin communication and transmit all content 22 in real-time. WebRTC leverages multiple standards and protocols. These include data streams, signaling, UDP/TCP, network sockets, NAT (Network Address Translation), ICE (Interactive Connectivity Establishment)/STUN (Session Traversal Utilities for NAT)/TURN (Traversal Using Relays around NAT) servers, JSEP (JavaScript Session Establishment Protocol), SDP (Session Description Protocol), and more.

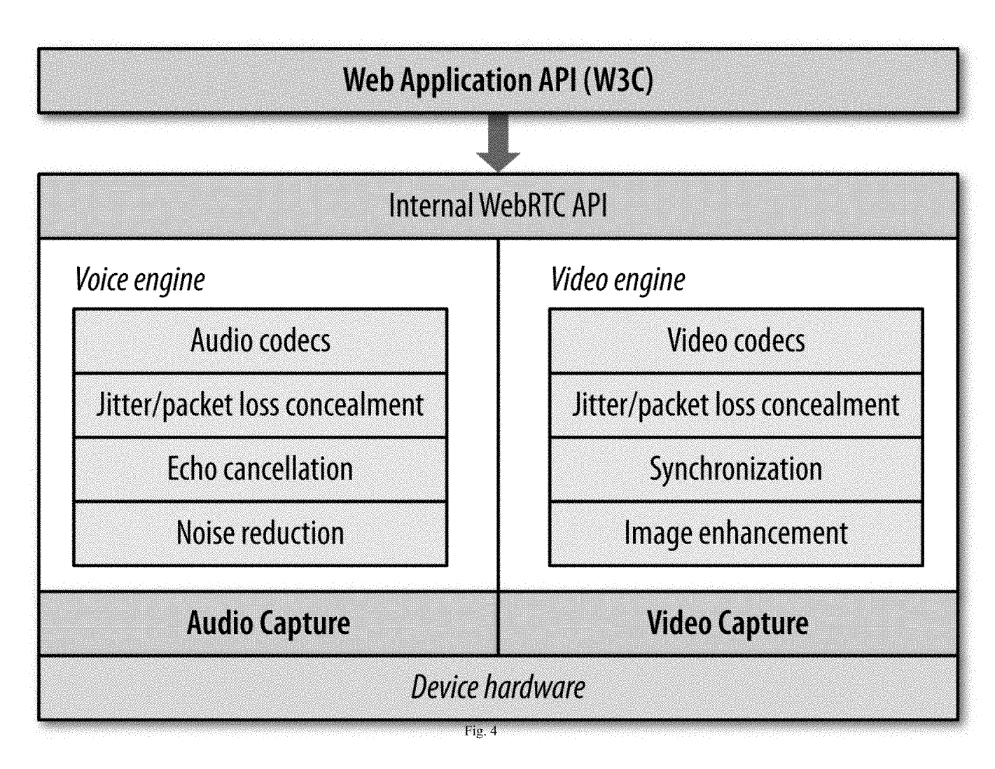

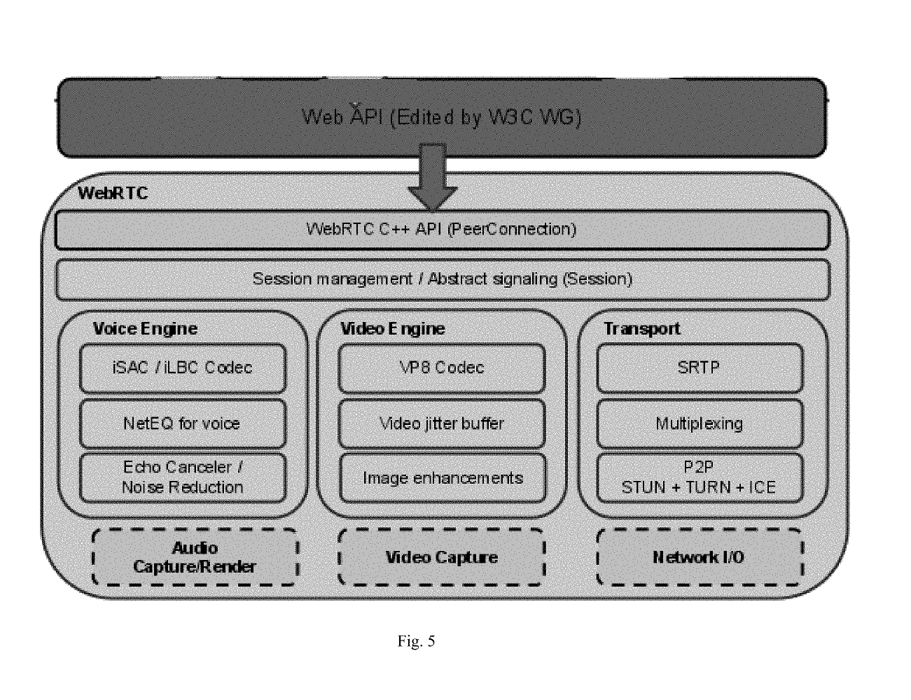

FIGS. 4 and 5 depict representative WebRTC client application focused protocol stacks. At the hardware level, audio or video data is captured. The audio or video data may be pre-processed for noise reduction, echo cancellation, image enhancement, or audio/video synchronization data. A CODEC (compression/decompression algorithm) may be applied to the audio and/or video data prior to network transport.

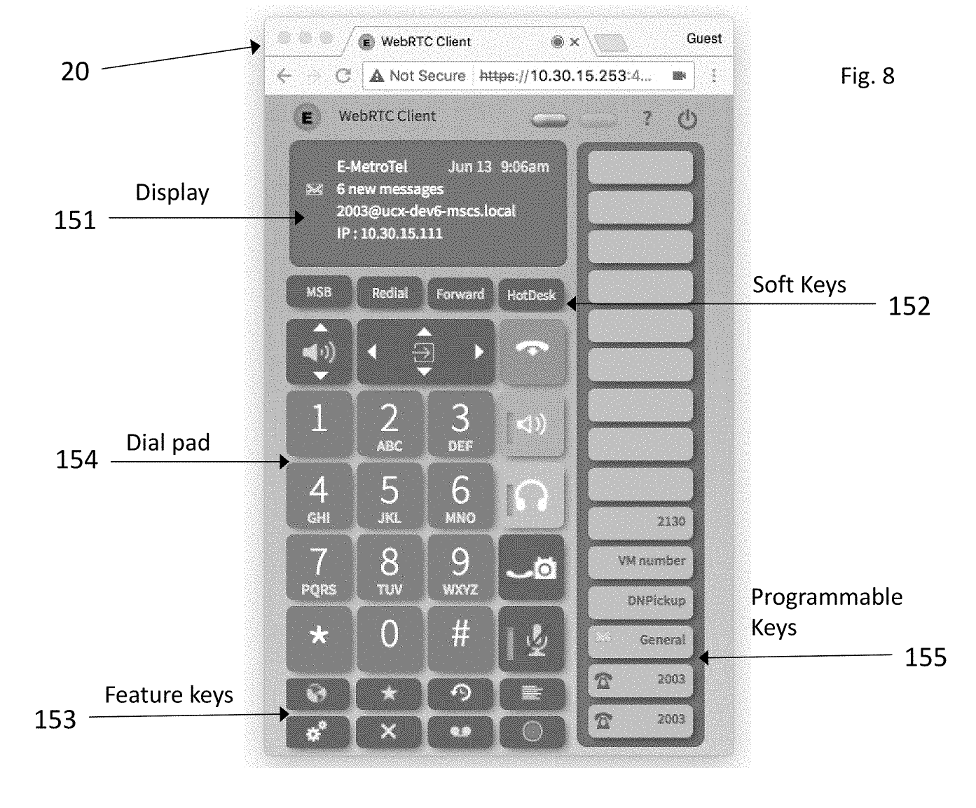

FIG. 8 illustrates an example of a WebRTC client 20 interface. The WebRTC client 20 is a web client implemented in an HTML page containing javascript served by a server. Loading the client page, the javascript creates a web socket connection to the server which handles asynchronous communications between the browser and the server. User interface (UI) event handlers in the client create WebRTC stimulus protocol events and send them to the call server 40 over the web socket via JSON payloads.

The example WebRTC client 20 interface shown in FIG. 8 is included in a WebRTC browser enabled for soft client application and configured to initiate and terminal calls. The WebRTC client 20 interface has buttons 152 153 154 155 that may be used to access particular call features, such as soft keys 152, feature keys 153, dial pad 154, and programmable keys 155. Additionally, the illustrated WebRTC client 20 interface has a display 151 that may be used to show information about established calling line information, features available or in use, or video data. For example, in the illustrated configuration, the computer WebRTC browser enabled soft client 20 interface includes a dial pad 154 to enable digit dialing to initiate call requests or invoke device feature codes. The computer WebRTC client 20 interface may include buttons referred to as feature keys 152 that may be programmed by users that when pressed enable particular calling features to be initiated, call requests, or invoke device feature codes. The WebRTC client 20 interface may include buttons referred to as line keys 153 that when pressed enable line call request for establishing a calling session.

The emulator module 10 and call server 40 may provide signaling to communicate with the WebRTC network facing and non-WebRTC network facing signaling to communicate by a stimulus-based protocol. Exemplary embodiments of the current invention employ stimulus based protocols for telephonic communication. A stimulus protocol is a type of protocol that is used to carry event notifications between end points. The call server 40 and emulator employ such protocol to communication with and control the operation of one or more clients 20 30 at each end of the communications link. A stimulus protocol is insensitive to the system state. In a common application, such a protocol will carry keystroke information from a client set to a central call server 40. It may also carry control information for simple types of text displays and other call signaling. UNIstim, and MiNET are representative stimulus based protocols.

Certain embodiments of the system 10 employ WebRTC stimulus based protocols for WebRTC facing clients 20, enabling the thinner clients to be controlled by the call server 40. In certain embodiments, Web socket event handlers receive asynchronous events from the server, process them, update user interface components like the display 151, icon updates, and telephony events. A bi-directional asynchronous javascript object notation (JSON) based protocol is employed between the client 20 and the emulator 10. For optimum real-time results, the WebRTC stimulus based protocol is run over web sockets, but other schemes like long polling can be used.

A partial representative set of client 20 30 to call server 40 stimulus based messages are offhook status, onhook status, keypresses (digit keys 154, soft keys 152, programmable keys 155, feature keys 153), device properties (type, number keys, display size), and other call signaling, control, and transmission messages.

A partial representative set of call server 40 to client 20 30 stimulus based messages are update display 151, update key icons, update lamp states (message waiting, mute, handsfree), download tone frequencies, play transducer tone (dialtone, dtmf tones, ring tones), set transducer (headset, handsfree) connect/disconnect media stream, and other call signaling, control and, transmission messages.

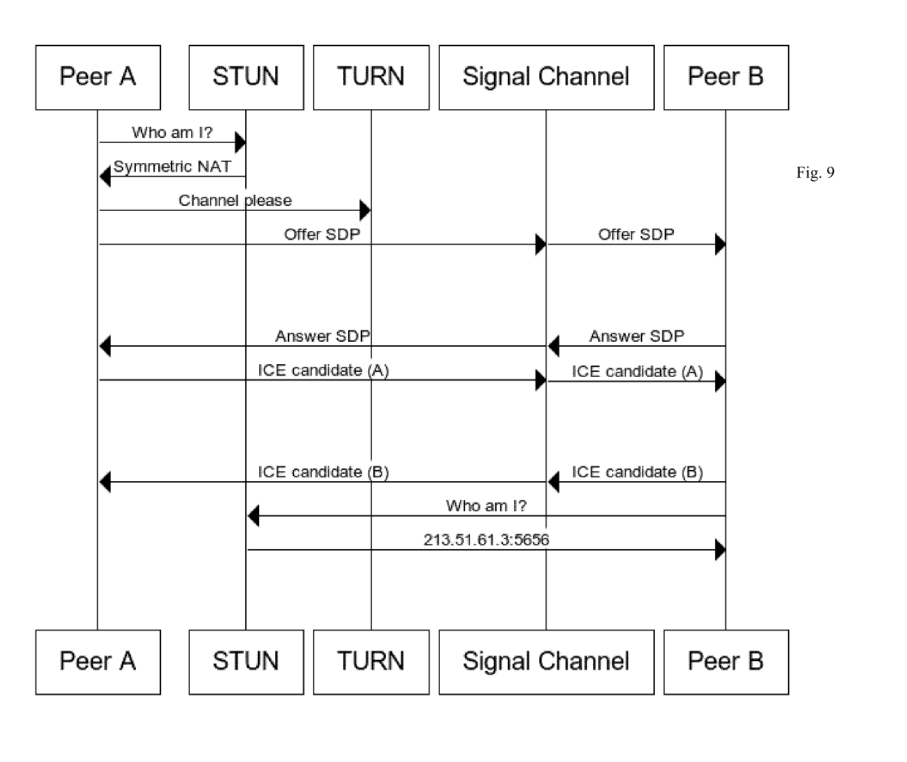

FIG. 9 depicts a representative WebRTC client (Peer A) to WebRTCX (Peer B) initial client interchange flow diagram in establishing a connection in certain network environments. Client Peer A sends a request to a STUN server on the Internet who replies with the client's public address and whether or not the client is accessible behind the router's NAT. Client Peer A creates a connection with a TURN server and tells peers to send packets to the server which will then be forwarded. Client Peer A initiated the connection by create an Offer SDP, which is sent to Client Peer B using a chosen signal channel. Client Peer B receives the Offer SDP over the signal channel and create an Answer SDP. Client Peer B sends this back to Client Peer A over the signal channel.

Exemplary embodiments of the invention facilitate WebRTC client 20 to non-WebRTC client 30 communication. Representative non-WebRTC clients 30 include a public switched telephone network (PSTN) client, a VoIP client, an analog phone, and others.

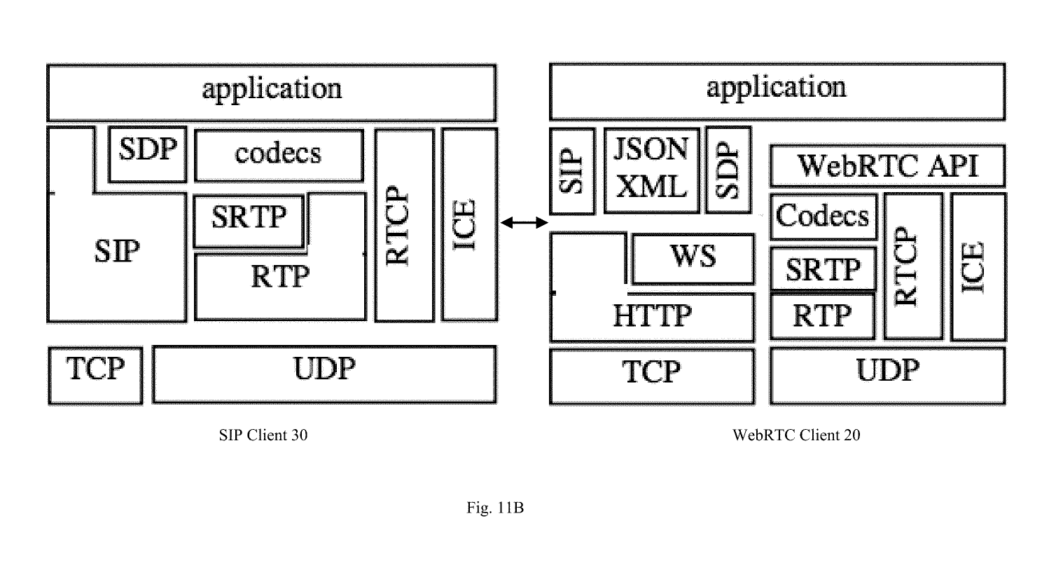

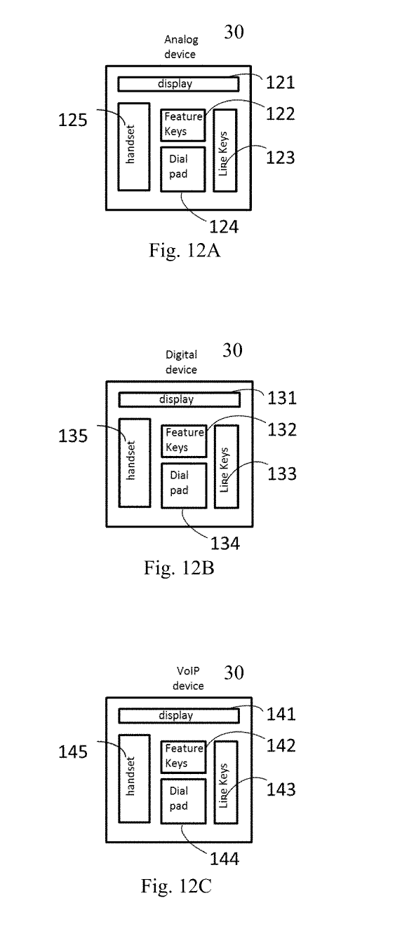

Other non-WebRTC clients 30 can interact with the system clients 30 include VoIP telephones, analog telephones, digital telephones, and others. A representative VoIP telephones is depicted in FIG. 12C. The VoIP telephone includes buttons to enable digit dialing to initiate call requests, invoke local device feature codes, or invoke telephone to SIP communication 40 server functionality. Representative, non-exclusive VoIP families include SIP, H.323 and H.248 based, and SIGTRAN. The example shown in FIG. 12C is a desktop VoIP telephone configured to be able to initiate and terminal calls via SIP Communication server. The desktop VoIP telephone has buttons that may be used to access particular features and, in turn, initiate associated line signal output traffic 30. For example, the desktop VoIP telephone has a display 141 that may be used to show information about established calling line information or features available or in use. For example in the illustrated embodiment, the desktop VoIP telephone includes a dial pad 144 to enable digit dialing to initiate call requests or invoke device feature codes or SIP Communication server functionality. The desktop VoIP telephone may include buttons referred to as feature keys 142 that may be programmed by users that when pressed enable particular calling features to be initiated, call requests or invoke device feature codes or SIP Communication server functionality. The desktop VoIP telephone may include buttons referred to as line keys 143 that when pressed enable line call request for establishing a calling session.

Non-WebRTC clients 30 can include an analog telephone. FIG. 12A illustrates an example of non-WebRTC client 30 in the form of an analog device that may be connected to a call server 40 for registration and identification to the call server 40 to permit interworking and connectivity. The example shown in FIG. 12A is a desktop analog telephone configured to be able to initiate and terminal calls via call server 40. The desktop analog telephone has buttons that may be used to access particular features and, in turn, initiate associated line signal output traffic 30. For example, the desktop analog telephone has a display 121 that may be used to show information about established calling line information or features available or in use. For example in the illustrated embodiment, the desktop analog telephone includes a dial pad 124 to enable digit dialing to initiate call request or invoke device feature codes or SIP Communication server functionality. The desktop analog telephone may include buttons referred to as feature keys 122 that may be programmed by users that when pressed enable particular calling features to be initiated, call requests or invoke device feature codes or call server 40 functionality. The desktop analog telephone may include buttons referred to as line keys 123 that when pressed enable line call request for establishing a calling session.

Similarly, FIG. 12B illustrates an example of a non-WebRTC client 30 include a digital telephone device. The example shown in FIG. 12B is a desktop digital telephone configured to be able to initiate and terminal calls via call server 40. The desktop digital telephone has many buttons that may be used to access particular features and, in turn, initiate associated line signal output traffic 30. For example, the desktop digital telephone has a display 131 that may be used to show information about established calling line information or features available or in use. For example in the illustrated embodiment, the desktop digital telephone includes a dial pad 134 to enable digit dialing to initiate call request or invoke device feature codes or call server 40 functionality. The desktop digital telephone may include buttons referred to as feature keys 132 that may be programmed by users that when pressed enable particular calling features to be initiated, call requests or invoke device feature codes or call server 40 functionality. The desktop digital telephone may include buttons referred to as line keys 133 that when pressed enable line call request for establishing a calling session.

One common, representative non-WebRTC client 30 employs SIP (Session Initiation Protocol) telephony protocol. SIP is a communications protocol for signaling and controlling multimedia communication sessions.

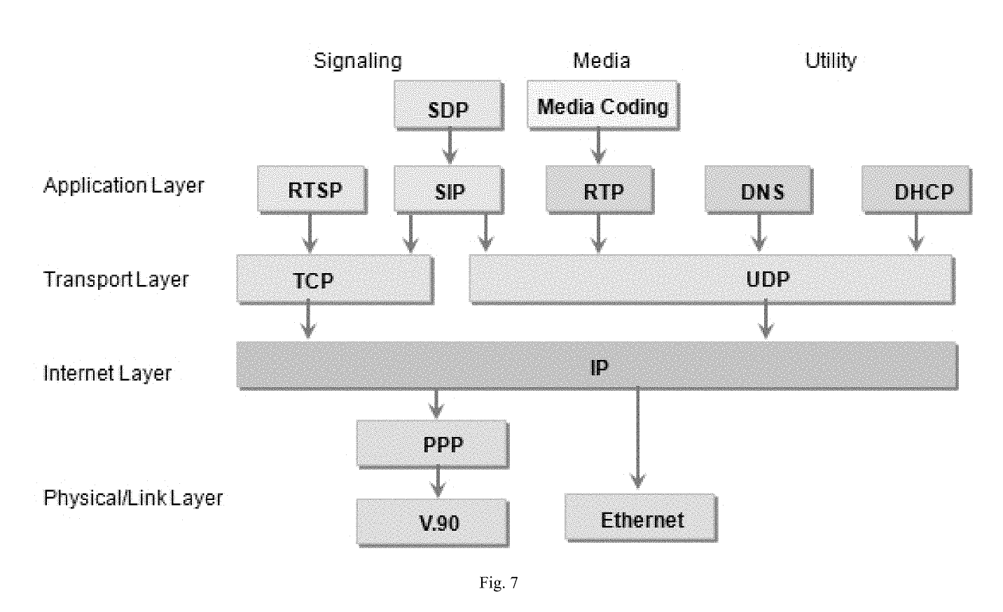

FIG. 7 depicts a representative SIP stack. The protocol defines the messages that are sent between endpoints, which govern establishment, termination and other essential elements of a call. SIP can be used for creating, modifying and terminating sessions consisting of one or several media streams. SIP is an application layer protocol designed to be independent of the underlying transport layer. SIP employs design elements similar to the HTTP request/response transaction model, with each transaction consisting of a client request that invokes a particular method or function on the server and at least one response.

SIP works in concert with these protocols by enabling Internet endpoints (i.e. user agents) to discover one another and to agree on a characterization of a session in which they can participate. For locating prospective session participants, and for other functions, SIP enables the creation of an infrastructure of network hosts (i.e. proxy servers) to which user agents can send registrations, invitations to sessions, and other requests. Some relevant aspects of SIP may be specified by an Internet Engineering Task Force (IETF) document Request For Comments (RFC) 3261, also denoted as IETF-RFC3261, the content of which is hereby incorporated by reference. IETF-RFC3261 describes SIP as “an application-layer control (signaling) protocol for creating, modifying, and terminating sessions with one or more participants. These sessions include Internet telephone calls, multimedia distribution, and multimedia conferences.”

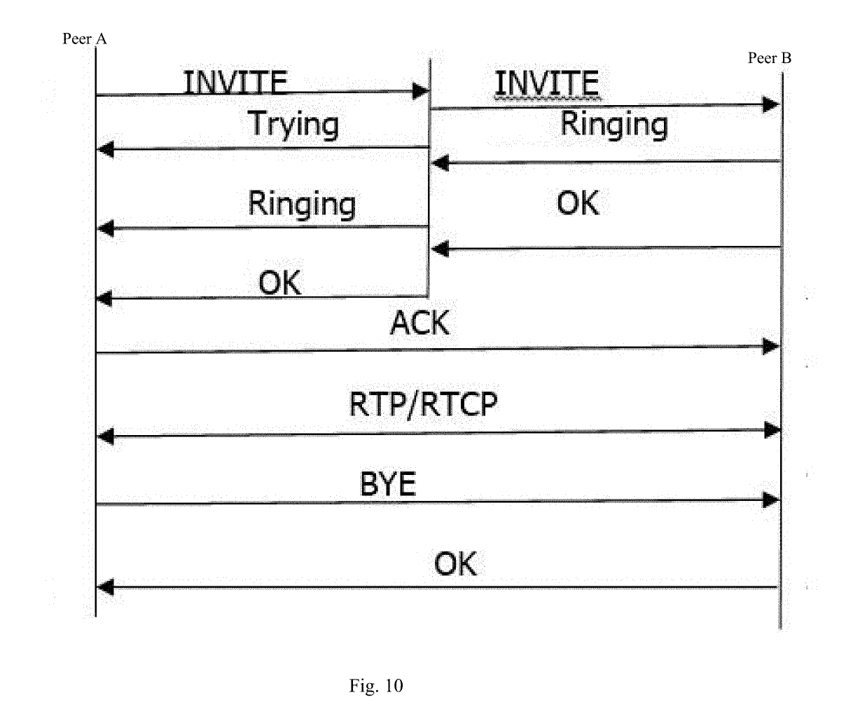

FIG. 10 depicts a representative SIP client 30 to SIP client 30 interchange flow diagram in establishing a connection in certain network environments. Peer A sends an invite request for Peer B that is sent to the call server 40 responsible for initiating a session. The call server 40 sends a Trying response immediately to the caller (Peer A) to stop the re-transmissions of the Invite request. The call server 40 searches for the Peer B address in the location server. After getting the address, it forwards the Invite request further. Thereafter, a Ringing message generated by Client B is returned Client A. An OK response is generated soon after Client B answers the telephone. Client B receives an ACK message from the Client A, after it receive the OK message. At the same time, the session gets established and RTP packets (primary client conversation) start flowing from both ends. After the conversation, Client A or Client B can send a BYE request to terminate the session. The BYE message is transmitted directly from one client to the other. Finally, a client sends an OK response to confirm the BYE message and the session is terminated.

The system includes an emulator module 10 operable to facilitate communication between WebRTC clients 20 and non-WebRTC clients 30 or WebRTC clients 20 and WebRTC clients 20. In certain configurations, the emulator module 10 acts to translate WebRTC client stimulus protocol based traffic to non-WebRTC stimulus based protocol traffic.

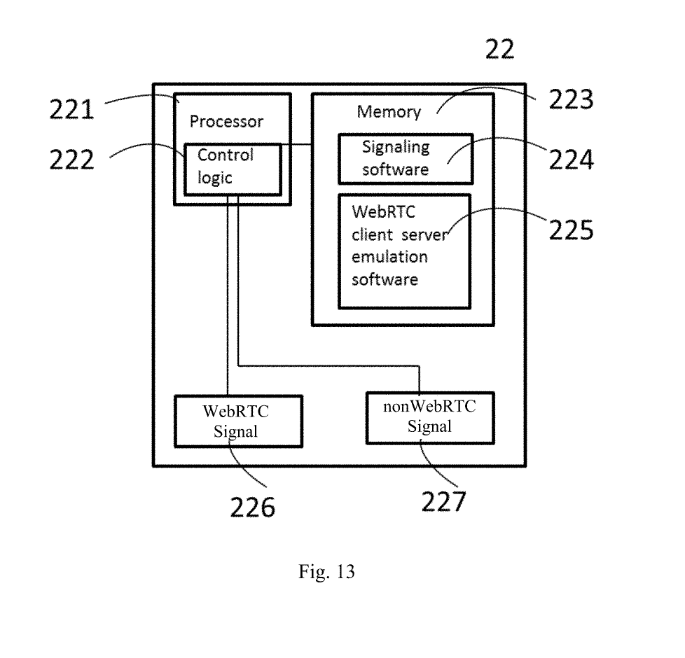

In exemplary configuration, the emulator module 10 is deployed to a server, having a processor and memory, such as a call server 40, in order to carry out its instructions. FIG. 13 illustrates a call server 40, including an emulator module 10, operable to facilitate communication between WebRTC clients 20 and non-WebRTC clients 30. In the embodiment illustrated in FIG. 13, the call server 40 includes a processor 221 having control logic 222 configured to enable the communication function of the attached devices. The call server 40 includes memory 223 in which signaling software 224 and emulator module 10 are stored.

The emulator 10 and call server 40 may be implemented using communications hardware, firmware, and/or software, and may include a suitably programmed computer processor configured to fetch, decode, and execute computer instructions and related hardware for performing some or all of the operations as herein described. For example, a microprocessor may fetch, decode, and execute computer instructions to retrieve, process, and/or store data to implement some or all of the described functions either alone or in combination with special-purpose communication hardware. In this manner, the emulator 10 may be implemented by a suitably programmed microprocessor executing a computer program or computer code segment to retrieve, process, and/or store data using associated communications hardware.

The call server 40 includes a first network interface 226 and a second network interface 227. The software components in conjunction with the processor, control logic, first network interface 226 and a second network interface 227, enable the call server 40 to establish communication sessions with WebRTC clients 20 and non-WebRTC clients 30, either within the communication system network or external to the network. The call server 40 identifies the incoming call requests and event traffic type facilitating communication sessions between the clients 20 30. Clients 20 30 communicate via the instructions of the emulator module 10 on the call server 40 from the respective networks 226 227.

An exemplary call server 40 contains network interfaces 226 227 to endpoints, CODECs, and all signaling and encapsulation functions required for WebRTC, Voice over IP transport, call signaling, and Quality of Service signaling. It can be embedded or a standalone device.

Effectively, over a first communications link 226 configured to communicate using to a second communications link or network 106, the emulator 10 can transfer and/or translate communications traffic between the signaling protocols so that devices on the first network side transmit and receive data using (i.e. “see”) only the first signaling protocol, while devices on the second side of the network transmit and receive data and see only the second signaling protocol. One or both of the protocols may be stimulus based.

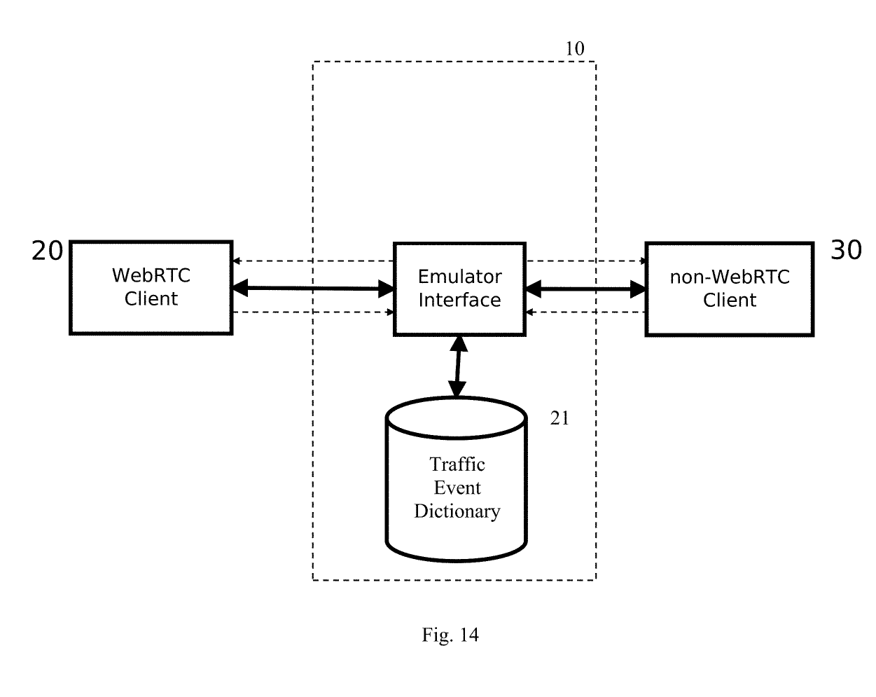

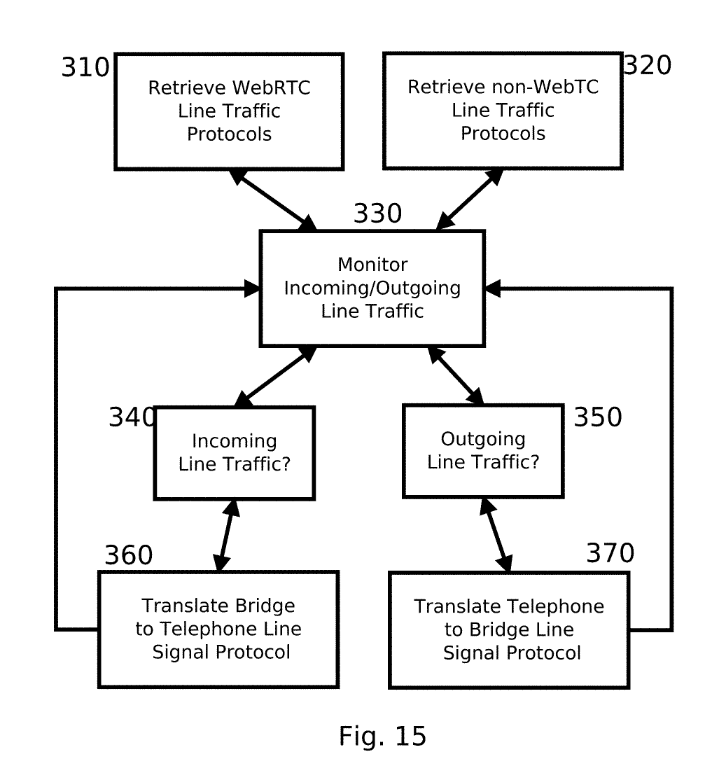

FIG. 14 illustrates an embodiment of the emulator module 10 as it may exist in operation. In an embodiment of the invention, the call server 40 with the emulator module 10 therein can then emulate a non-WebRTC client 30 and relay the communication session to a WebRTC client 20 and emulate a non-WebRTC client 30 and relay the communication session to a WebRTC client 20 in order to establish and maintain a communication session, including call control signaling and content transmission.

In certain configurations, the emulator module processes WebRTC client 20 to WebRTC client 20 peer-to-peer calls, differing from the published WebRTC protocol, peer-to-peer calls, WebRTC stimulus calls employ peer-to-server (via emulator module 10) calls. This enables call features like multiparty conference, call recording, PSTN and non-WebRTC calls. In processing these WebRTC client 20 to WebRTC client 20 peer-to-peer calls, the WebRTC client signaling message is initiated from the WebRTC client 20 for both the originating and terminating leg of a call. Additionally, the WebRTC answer signaling message is initiated from the call server 40 for both the originating and terminated leg of a call.

In certain WebRTC client to non-WebRTC clients, the emulator module 10 relays ICE candidate messages between the WebRTC client 20 and the vendor adapter. Offer and answer SDP is managed by the emulator module 10 and not passed directly to the vendor adapter 42. Instead, an abstracted interface is defined in the vendor adapter interface 411 so the vendor stimulus protocol does not require an SDP parser. The vendor adapter interface provides a unified API for the WebRTC client to be vendor agnostic. The vendor adapter converts the WebRTC stimulus protocol to the specific stimulus protocol used by such vendor.

The call server 40 and emulator module 10 support all signaling functions of a client 20 30 including processing the events and/or signals associated with the line package. The emulator module 10 includes an instruction set to translate the event traffic of a WebRTC client 20 to that of a non-WebRTC client 30 and vice versa. More specifically, the emulator module 10 translates outgoing traffic 30 from the traffic type of the output client 20 to the traffic type 32 of the target recipient client 30. More specifically, the emulator module 10 translates incoming traffic 34 from the traffic type of the external client 30 to the traffic type 36 of the recipient client 20.

The emulator module 10 translation is facilitated via a traffic event dictionary 24. The traffic event dictionary 24 contains the event traffic types of the client devices 20 30. The event traffic type includes those corresponding to different signal activity such as client control, call control signaling, or call content transmission. For example, an event traffic entry may represent a keypress, phone display message, start or stops tone, switching tones such as a dial tone or ring back tone, call content data, or phone identification. In certain configurations, an event traffic entry includes a type of client type, an event traffic activity type, and a packet representation of that event traffic activity type. In one configuration, event traffic entries are created from publicly available information. In another configuration, packet monitoring is used to capture data packets from different event traffic activity. In other configurations, the event traffic entries include emulator response or directives to the event traffic.

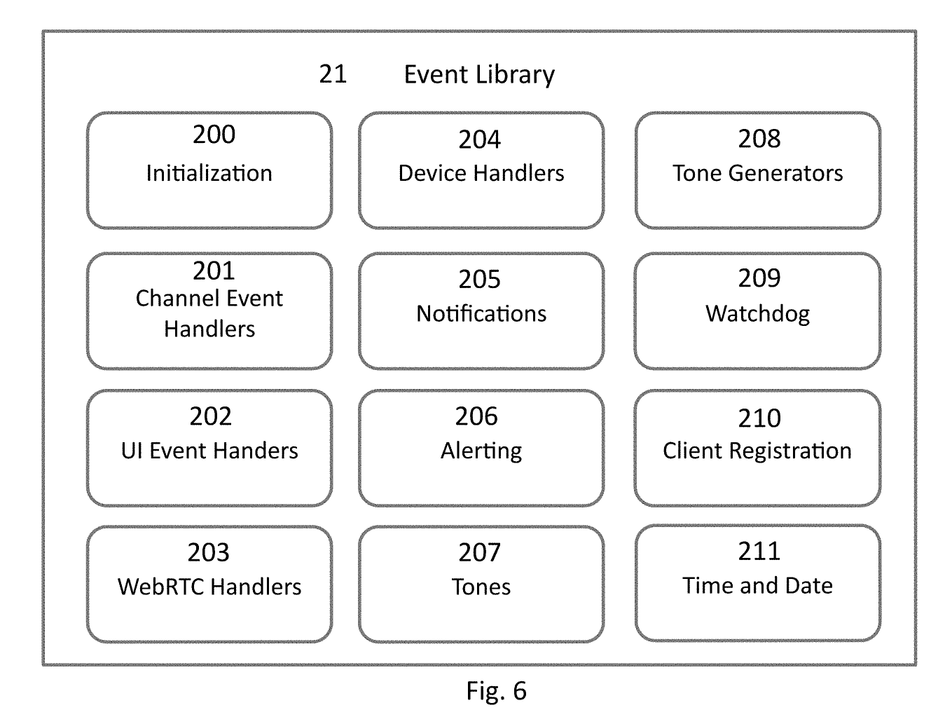

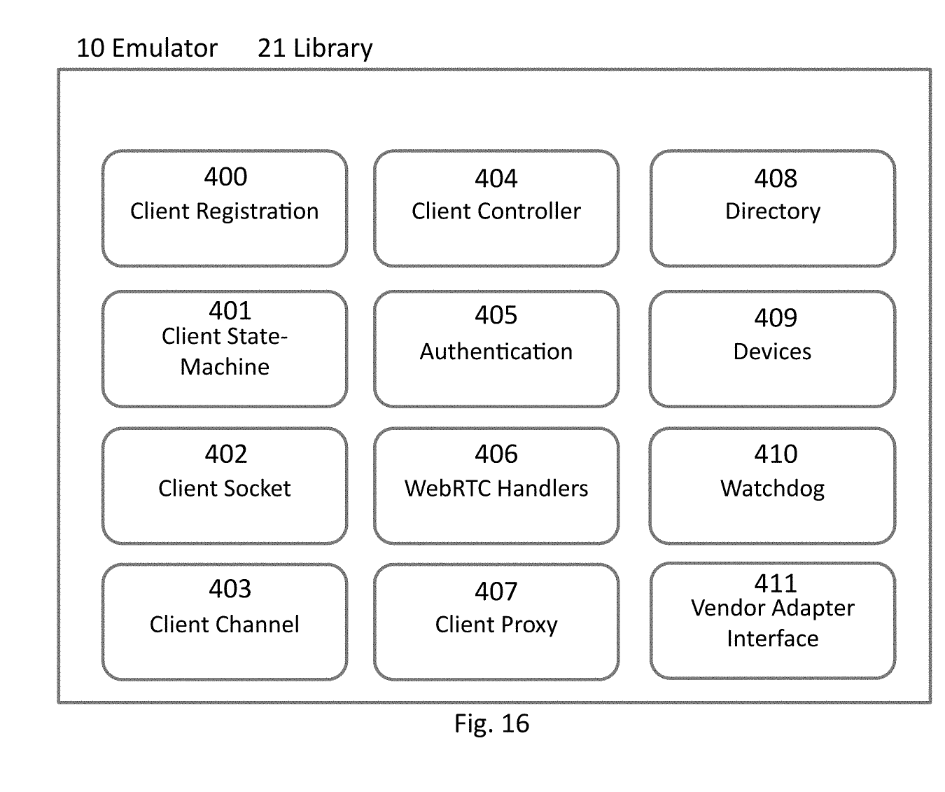

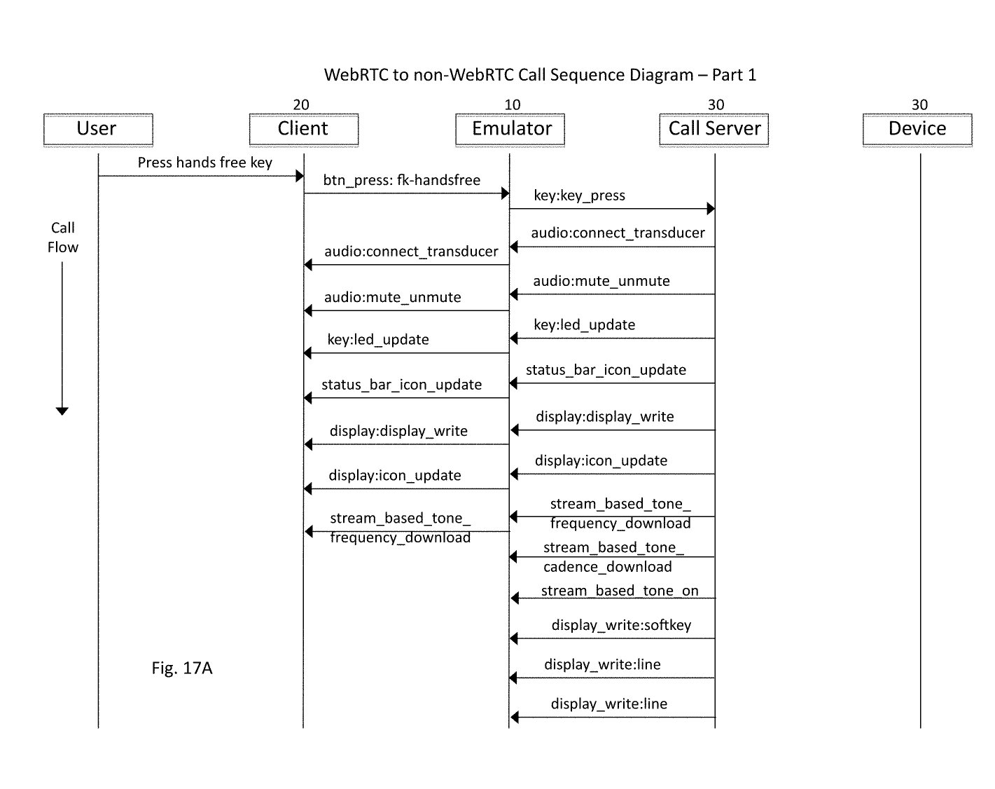

FIG. 6 illustrates representative traffic event entries while FIG. 16 illustrates representative response instructions to traffic event entries. One traffic event is initialization 200. At initialization 200 and registration 210, the emulator module 10 receives an initialization web socket request or registration request and includes a response instruction for establishing a channel for the WebRTC stimulus protocol 110. Additional possible client registration 400 response instructions include receiving the client identification by WebRTC stimulus protocol 201 messages and registering/mapping the client with the non-WebRTC interface, such that the emulator module maintains two connections for this client session, one for the WebRTC stimulus protocol 201 and one for the non-WebRTC vendor adapter interface 411. Additional possible response instructions include authentication 405. Client authentication includes for requesting the user's login credentials and validating the credentials. A session token is issued so subsequent page requests can be validated against the session token. A web socket session token is also issues to authenticate the web socket connection.

Another traffic event is channel handling 201. At channel handling 201, the emulator module 10 receives a channel event and includes a response for registering asynchronous callback handlers. Additional possible response instructions include client state updates 401. In certain configurations, call server 40 side client events are processed by the client state-machine 401. Events can include system event like timers, incoming WebRTC stimulus protocol 201 messages, and vendor stimulus protocol 120 messages from the non-WebRTC interface 411. Call server 40 side state for a registered client is processed by an instance of the client state-machine 401, enabling per-state event handlers. Additional possible response instructions include client socket management 402. As a web socket connection is commonly over a designated transport like TCP, the client socket management instructions include multiplexing multiple client channels 403 over the TCP web socket, where an instance of the client socket is created for each instance of a registered WebRTC client 20. Additional possible response instructions include client channel management 403. Client channel management includes transferring WebRTC stimulus protocol messages to and from the WebRTC client 20. Client channel management includes receiving messages from the WebRTC traffic event library 21 and from the client state-machine 401, and delivers messages to the clients. Additional possible response instructions include client control 404, the client controller processes WebRTC client 20 requests. For example, after authenticating the user, the client controller 404 looks for an existing client state-machine 401 instance. If an instance is found, the WebRTC client 20 interface is rendered and a request sent to the client proxy 407 to update the WebRTC client's state. If an instance is not found, one is created and the WebRTC client 20 interface is rendered.

Another traffic event is UI event handling 202, where the emulator module 10 receives a channel event such as buttons presses, page reloads, or keyboard shortcuts and includes a response of initiating corresponding outgoing WebRTC stimulus protocol messages. Another traffic event is WebRTC handling 203, where the emulator module 10 receives a WebRTC event such as WebRTC Javascript API for events like OnAnswer, OnCandidate, and the like and responds with corresponding event handlers. Additional possible response instructions include client proxy actions. Commonly, WebRTC client 20 UI state is managed with through asynchronous web socket messages. Therefore, this state is synchronized with the client application if the user reloads the WebRTC client interface. Outgoing WebRTC stimulus protocol 110 messages originated from the client state-machine 401 are sent from the client proxy 407. All messages except for transient type messages are cached by the client proxy 407. If a page reload occurs, the client proxy 407 resends each of the stateful messages to the client, ensuring that the client is updated to the same state as before the page was reloaded. This includes client state like display contents, key icons and cadences, and similar state conditions.

Another traffic event is device handling 204, where the emulator module 10 receives a user to selection for desired input and output devices for hands-free and head set modes of the client and response of detection and registration of microphone and speakers devices of the client. Additional possible response instructions include persisting the configured hands-free and headset input and output devices. Device persistence is associated with the WebRTC by keys such as the client's IP address.

Another traffic event is notification 205, where the emulator module 10 receives incoming call notifications and includes a response of processing the notification. Another traffic event include alerting 206, where the emulator module 10 receives alerting, buzz, audible ring alerting tones, audible paging tones, visual alerting, and desktop notifications and paging tones using the tone generators module 208, as well as visual alerting and notifications 205 and includes a response of processing the alert. Other traffic events include tone request and generation 207 208, where the emulator module 10 receives tones generation requests and includes a response of generating a tone.

WebRTC stimulus protocol includes an API to specify various tones 207 including alerting tones (ring tones), domestic and international dial tones, and paging tones. The tones are played out to the user, on any of the configured output devices using the Tone Generators 208.

Another traffic event includes tone generators requests 208, where the emulator module 10 receives requests for tones, such as domestic and international dial tones, DTMF tones, ringing tones, ring back tones, key feedback tones, and other telephony tones and includes response instructions of generating multiple oscillators, each with their own frequency, start offset, on duration, and off duration. Combining multiple oscillators allows the tone generator to generate an unlimited number of tones.

Another traffic event is connectivity status requests 209, where the emulator module 10 receives connectivity status requests and includes a response of connectivity status response. The WebRTC Library 21, WebRTC Stimulus Protocol 110, and the Vendor Stimulus Protocol 120 provides a multilevel heartbeat and user notification mechanism to detect and notify the user when connectivity is lost between the WebRTC Client 20 and the emulator module 10 or between the emulator module 10 and the vendor channel 51. Additional, the watchdog 209 module includes a recovery mechanism to automatically restore operation of the WebRTC client 20 when the connectivity is restored.

Another traffic event includes multiparty call requests, where the emulator module 10 receives requests for multiparty call requests and includes response instructions of setting up a call among multiple parties.

Another traffic event includes call server recording, where the emulator module 10 receives requests for call server recording of a call and includes response instructions of recording the call content at the call server 40.

The traffic event library 21 may include one or more vendor adapter sub-libraries 42, with those including traffic events, and stimulus protocol instructions for types or model of non-WebRTC clients 30.

Other traffic events include phone off hook, phone on hook, phone DTMF on or off, ringing, hangup, dialtone, busytone, and other messages and corresponding responses.

The emulator module 10 receives event traffic 30 from WebRTC client such as call initiation, conference calls, initiate call forwarding, and other functions. Primary line signal output traffic 30 includes call control signaling and call content transmission. Representative WebRTC client line signal output traffic 30 includes keypress signals, phone display messages, start and stops tones, switching tones (eg dial tones, ring back), switch speech path, audio/content traffic data, phone identification, and other traffic.

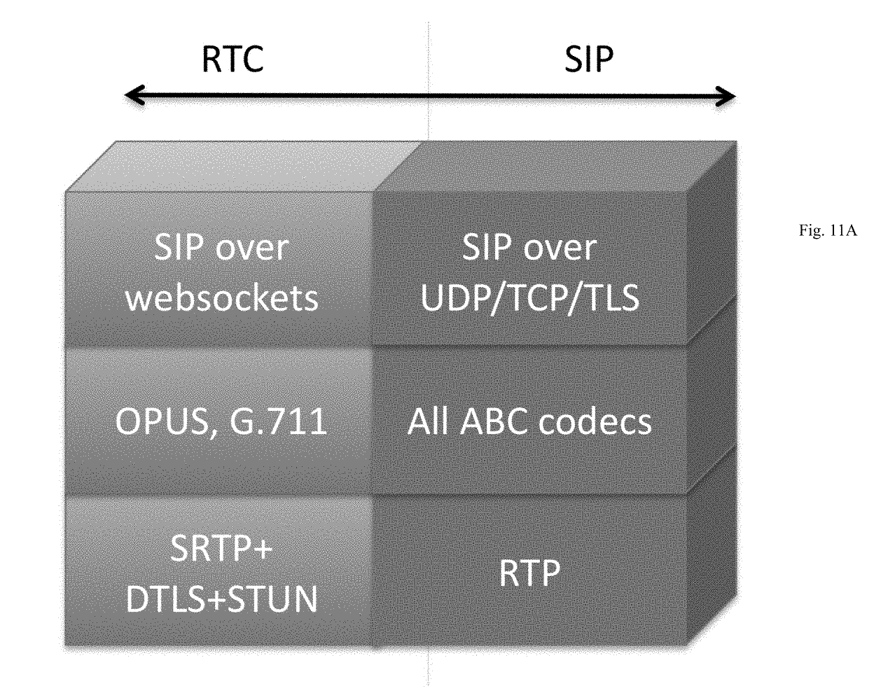

FIGS. 11A and 11B illustrate parallel representative stacks of WebRTC clients and non-WebRTC clients as a basis for emulation. For example, a series of WebRTC client 20 content 22 packets might represent audio data compressed with the OPUS codec transported over a web socket connection. The emulator module 10 may convert that audio data to G.729 codec transported over a UDP connection.

Having disclosed major elements of the system 10, operation of the system 10 is now disclosed. FIG. 15 illustrates exemplary process of use of the system. Communication flow can include provisioning, session establishment, and content transmission. Provisioning may typically be done in a temporally separate from session establishment and content transmission.

In certain processes, a session is created when one or more client 20 30 is mapped to one or more emulator modules 10. The clients 20 30 may be controlled by the stimulus-based network by using the traffic event signaling. User action to the call session are communicated back over the stimulus network via events generated by the user's action. The establishment of a call session may be based on a request from either client 20 30. Once a signaling path is established, the media can pass from the client 20 to client 30.

The event traffic entries for the protocols of the WebRTC clients 20 is retrieved 310. The event traffic entries for the protocols of the non-WebRTC clients 30 is retrieved 320. Incoming and outgoing traffic is monitored 330. Incoming event traffic is detected 340 and translated 360. Outgoing event traffic is detected 350 and translated 370. More consideration to each of the steps is described below.

At step 310, the event traffic entries for the protocols of the WebRTC clients 20 is retrieved. At step 320, the event traffic entries for the protocols of the non-WebRTC clients 30 is retrieved. Representative line entries retrieved are NAT traversal, session negotiation, media path, the media transport path, codecs, and security for the respective clients 20 30.

At step 330, emulator module 225 monitors the line for outgoing event traffic 30 and incoming event traffic 34. With reference to the protocol stacks of FIGS. 11A and 11B, and the following table, the emulator module 225 translate the incoming and outgoing event traffic according to the event traffic type:

| Property | SIP | WebRTC |
|---|---|---|
| Session Negotiation | SDP, offer/answer | SDP, trickle |
| Media Transport | RTP, STRP | SRTP, new RTP |
| | | profiles |
| Media Transport Path | Separate: audio/video, | Same path for |
| | RTP, RTCP | control and media |
| Audio codecs | Commonly G.711, | G.711, OPUS, |
| | G.722, G.729, Speex | others optional |
| Video codecs | Commonly H.261, | Likely H.264, |
| | H.263, H.264 | VP8 |

For outgoing event traffic 30, the emulator module 225 determines the event traffic type by comparing the event traffic to those in the traffic event dictionary 24 entries of the clients 30. The emulator module 225 the translates the event traffic 360 to that of the external event traffic protocol with reference to the traffic event dictionary 24 entries of the external client 20 30. For incoming event traffic 34, the emulator module 225 determines the event traffic type by comparison to the event traffic to those in the traffic event dictionary 24 entries of the external client. The emulator module 225 then translates the event traffic 370 to that of the external device with reference to the traffic event dictionary 24 entries of the other client.

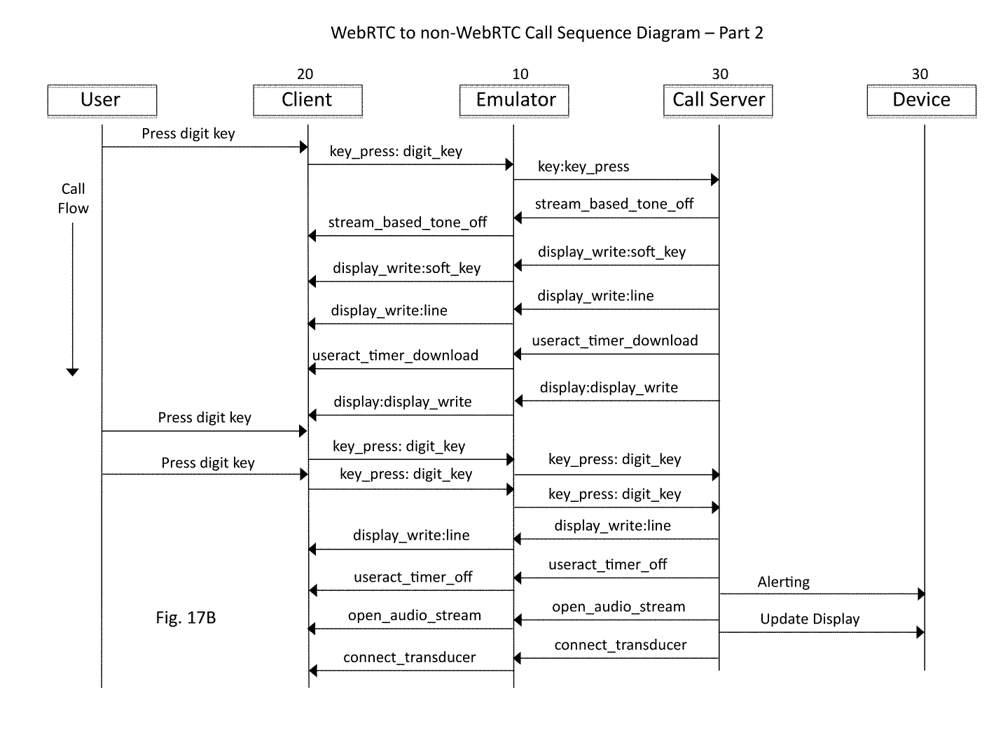

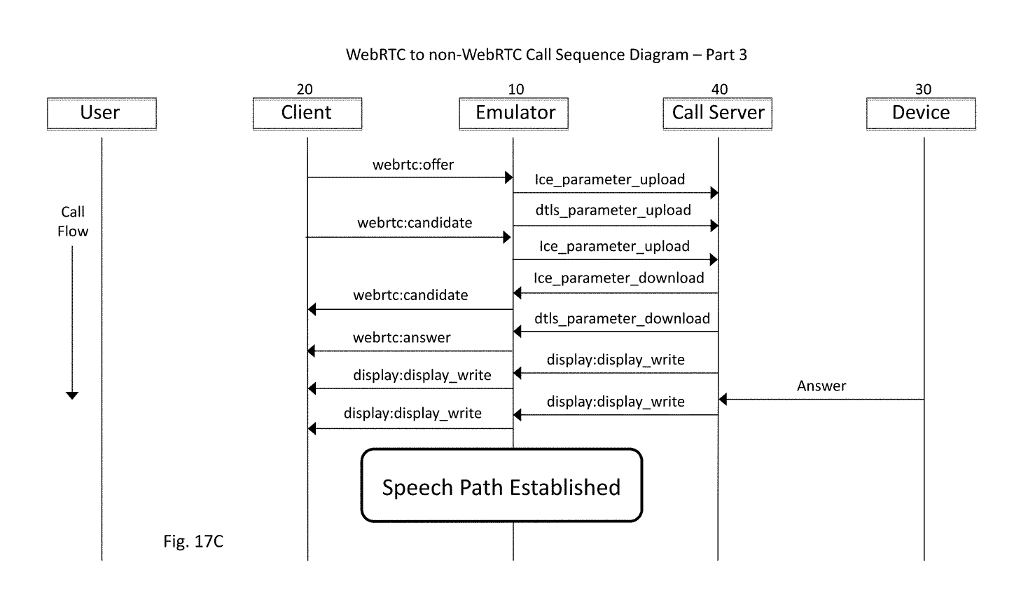

FIGS. 17A-17C illustrate a WebRTC client 20 to non-WebRTC client 30 partial call sequence. A user initiates a call at the WebRTC client 20 interface. The user engages the hands-free hardware and digit keys, where stimulus based protocol messages from the actions are transmitted to and received from the emulator module 10. The emulator module 10 intermediates communication with the nonWebRTC client 30, where alert and display update messages are transmitted. The user of the nonWebRTC client 30 client answers and a speech path is established.

Insofar as the description above and the accompanying drawing disclose any additional subject matter that is not within the scope of the single claim below, the invention are not dedicated to the public and the right to file one or more applications to claim such additional inventions is reserved.

What is claimed is:

1. A system for bidirectional emulation of telephone communication, said system comprising:
an emulator module having a traffic event dictionary;
said traffic event dictionary having event traffic entries corresponding to traffic events for WebRTC clients;
said line signal dictionary having stimulus protocol based instructions corresponding to WebRTC event traffic entries;
said traffic event dictionary having event traffic entries corresponding to traffic events for non-WebRTC clients;
said line signal dictionary having stimulus protocol based instructions corresponding to non-WebRTC event traffic entries;
said emulator module configured to receive and monitor incoming and outgoing event traffic between a WebRTC client and a non-WebRTC;
said emulator module configured to retrieve the event traffic entries for said WebRTC clients from said traffic event dictionary and retrieve the event traffic entries for said non-WebRTC clients from said traffic event dictionary;
said emulator module configured to translate said WebRTC client event traffic to said non-WebRTC client event traffic over their respective stimulus protocol based instructions corresponding to their respective event traffic entries.

2. The device of claim 1, wherein said non-WebRTC client is an analog device.

3. The device of claim 1, wherein said non-WebRTC client is a digital device.

4. The device of claim 1, wherein said non-WebRTC client is a SIP client.

5. The device of claim 1, wherein said non-WebRTC client is a PSTN client.

6. The device of claim 1, wherein identification of said WebRTC client or said non-WebRTC client is determined by an IP address.

7. The device of claim 1, wherein identification of said WebRTC client or said non-WebRTC client is determined from manually received input.

8. The device of claim 1, wherein identification of said WebRTC client or said non-WebRTC client is facilitated by lookup to ports to which said telephone device or said external telephone system are connected.

9. The device of claim 1, wherein said emulator is communicatively interposed adjacent said WebRTC clients.

10. The device of claim 1, further comprising a call server, said call server a first facing network interface, a second facing network interface, CODECs, and signaling and encapsulation functions required for WebRTC, Voice over IP transport, call signaling, and quality of service signaling, wherein said emulator module is disposed on said call server.

11. A process for bidirectional emulation of telephone communication, said system comprising:
providing an emulator module having a traffic event dictionary;
said traffic event dictionary having event traffic entries corresponding to traffic events for WebRTC clients;
said line signal dictionary having stimulus protocol based instructions corresponding to WebRTC event traffic entries;
said traffic event dictionary having event traffic entries corresponding to traffic events for non-WebRTC clients;
said line signal dictionary having stimulus protocol based instructions corresponding to non-WebRTC event traffic entries;
said emulator module configured to receive and monitor incoming and outgoing event traffic between a WebRTC client and a non-WebRTC;
said emulator module configured to retrieve the event traffic entries for said WebRTC clients from said traffic event dictionary and retrieve the event traffic entries for said non-WebRTC clients from said traffic event dictionary;
said emulator module configured to translate said WebRTC client event traffic to said non-WebRTC client event traffic over their respective stimulus protocol based instructions corresponding to their respective event traffic entries.

12. The device of claim 11, wherein said non-WebRTC client is a PSTN client.

13. The process of claim 11, wherein said non-WebRTC client is a digital client.

14. The process of claim 11, wherein said non-WebRTC client is a SIP client.

15. The process of claim 11, wherein identification of said WebRTC client or said non-WebRTC client is determined by an IP address.

16. The process of claim 11, wherein identification of said WebRTC client or said non-WebRTC client is received from manually input.

17. The process of claim 11, further providing a call server, said call server a first facing network interface, a second facing network interface, CODECs, and signaling and encapsulation functions required for WebRTC, Voice over IP transport, call signaling, and quality of service signaling, wherein said emulator module is disposed on said call server.

18. A system for bidirectional emulation of telephone communication, said system comprising:
an emulator module having a traffic event dictionary;
said traffic event dictionary having event traffic entries corresponding to traffic events for WebRTC clients;
said line signal dictionary having stimulus protocol based instructions corresponding to WebRTC event traffic entries;
said emulator module configured to receive and monitor incoming and outgoing event traffic between a first WebRTC client and a second WebRTC client;
said emulator module configured to retrieve the event traffic entries for said WebRTC clients from said traffic event dictionary and retrieve the event traffic entries for said WebRTC clients from said traffic event dictionary;
said emulator module configured to actively bridge said first WebRTC client event traffic to said second WebRTC client event traffic over their respective stimulus protocol based instructions corresponding to their respective event traffic entries.

19. The system of claim 18, wherein said traffic event dictionary includes multiparty call event traffic entries and response instructions.

20. The system of claim 18, wherein said traffic event dictionary includes call server content recording traffic entries and response instructions.
